(19) United States
(12) Patent Application Publication
(10) Pub. No.: US 2021/0192378 A1
(43) Pub. Date: Jun. 24, 2021

(54) QUANTITATIVE ANALYSIS METHOD AND APPARATUS FOR USER DECISION-MAKING BEHAVIOR

(71) Applicant: BEIJING BAIDU NETCOM SCIENCE TECHNOLOGY CO., LTD., Beijing (CN)

(72) Inventors: Xinjiang LU, Beijing (CN); Renjun HU, Beijing (CN); Hui XIONG, Beijing (CN)

(21) Appl. No.: 17/128,904

(22) Filed: Dec. 21, 2020

(30) Foreign Application Priority Data
Jun. 9, 2020 (CN) 202010518137.1

(51) Int. Cl. G06N 5/04; G06N 20/00

(52) U.S. Cl. CPC G06N 5/045; G06Q 30/0202; G06N 20/00

(57) ABSTRACT

The present application proposes a quantitative analysis method for a user decision-making behavior and an apparatus, which relate to the fields of big data calculation and artificial intelligence in computer technology. At least one quantified decision factor related to making a target decision by a user is inputted into a machine learning model; the machine learning model further analyzes the decision factor; and finally a prediction result of making the target decision by the user is determined according to an output of the machine learning model. Therefore, it is possible to analyze the decision factor for making the target decision by the user to obtain the prediction result of making the target decision, thus enriching analysis needs for the user decision-making behavior.

### CROSS-REFERENCE TO RELATED APPLICATIONS

This application claims priority to Chinese Patent Application No. 202010518137.1, filed on Jun. 9, 2020 and entitled “QUANTITATIVE ANALYSIS METHOD AND APPARATUS FOR USER DECISION-MAKING BEHAVIOR”, which is hereby incorporated by reference in its entirety.

### TECHNICAL FIELD

The present disclosure relates to the fields of big data calculation and artificial intelligence in computer technology, and in particular to a quantitative analysis method for a user decision-making behavior and an apparatus.

### BACKGROUND

Some research data show that an adult makes 35,000 decisions intentionally or unintentionally in a day. These decisions are usually made based on a user's certain subjective habits in combination with objective conditions. How to make quantitative analysis on the user's behavior so that a computer can predict whether the user will make a certain decision based on the quantified subjective and objective conditions, is a common application scenario in big data technology. Especially for service providers such as a merchant, after obtaining data that can quantitatively describe how users make decisions, the computer can use these data to generate a prediction value. Finally, based on the prediction value calculated by the computer, the merchant can determine whether the users will choose the merchant and how to optimize the merchant itself to make the prediction value higher. Therefore, the computer needs to perform specific quantitative analysis on the users' abstract behaviors, so that the prediction value can be calculated.

In the most common scenario of user decision-making behavior analysis in the prior art, the computer as an executive entity can obtain keywords that are searched for by a user when using a terminal device such as a mobile phone to surf the Internet, and determine the user's behavior based on these keywords searched for by the user and recommend behavior-related information to the user. For example, when the user uses the mobile phone to search for “coffee” many times, the computer can determine that the user's behavior is to drink coffee based on the acquired keyword “coffee”, and then push information related to nearby coffee shops to the user's mobile phone.

With the prior art, the user decision-making behavior analysis performed by the computer is only a simple keyword correspondence and information recommendation, and it is not possible to make quantitative analysis for which subjective and objective factors the user considers to make a decision. In particular, it is impossible to use quantified data to characterize a reason for the user's decision, and thus it is impossible to predict whether the user will make a decision. As a result, the method for user decision-making behavior analysis in the prior art is relatively single, which cannot meet diverse analysis needs.

### SUMMARY

The present application proposes a quantitative analysis method for a user decision-making behavior and an apparatus. At least one quantified decision factor related to making a target decision by a user is inputted into a machine learning model; the machine learning model further analyzes the decision factor; and finally a prediction result of making the target decision by the user is determined according to an output of the machine learning model. Therefore, it is possible to analyze the decision factor for making the target decision by the user to obtain the prediction result of making the target decision, thus enriching analysis needs for the user decision-making behavior.

A first aspect of the present application provides a quantitative analysis method for a user decision-making behavior, including: acquiring at least one decision factor related to making a target decision by a user; where each of the decision factor is represented by a numerical value obtained by quantifying information of the user or information of the target decision; inputting the at least one decision factor into a machine learning model, and determining, according to an output of the machine learning model, a prediction result of making the target decision by the user.

Specifically, the quantitative analysis method for a user decision-making behavior provided by this embodiment has the following beneficial effects that: the decision factor for making the target decision by the user can be analyzed to obtain the prediction result of making the target decision, which ensures the interpretability and effectiveness of the user decision-making behavior, and thus enriches the analysis needs for the user decision-making behavior.

In an embodiment of the first aspect of the present application, the information of the user includes: a type of a decision that the user prefers to make, a time when the user makes the target decision, and a location where the user makes the target decision; the information of the target decision includes: a time distribution of the target decision being made cumulatively.

Specifically, the quantitative analysis method for a user decision-making behavior provided by this embodiment has the following beneficial effects that: from the user's perspective and from the perspective of the target decision itself, subjective and objective conditions of making the target decision by the user are measured as comprehensively as possible, which can analyze the user decision-making behavior more accurately and descriptively.

In an embodiment of the first aspect of the present application, the method further includes: acquiring multiple decisions made by the user and at least one decision factor related to each of the decisions; inputting each decision of the multiple decisions and the at least one decision factor related to the each decision into the machine learning model in turn, and training the machine learning model.

Specifically, the quantitative analysis method for a user decision-making behavior provided by this embodiment has the following beneficial effects that: a reason for the user decision-making behavior can be analyzed in advance through historical decision data, so that an actual choice of the user can be restored more truly based on the machine learning model calculated from real data when subsequently analyzing each decision of the user, thereby analyzing the user decision-making behavior.

In an embodiment of the first aspect of the present application, the machine learning model includes: an embedding module, a self-projection attention module, a multilayer perceptron MLP module, and a decision structure learner module; where the embedding module is used to initialize each inputted decision factor as a multi-dimensional vector to obtain a first matrix; the self-projection attention module is used to assign a value to each initialized vector in an embedding matrix according to a component projected by other vector on the each vector to obtain a second matrix; the MLP module is used to fuse the first matrix and the second matrix to obtain a third matrix, where the third matrix includes a likelihood value corresponding to each of the at least one decision factor, and the third matrix is subjected to regularization processing of an L2 norm to obtain a sparse fourth matrix; the decision structure learner module is used to determine a scalar value of making the target decision by the user according to the fourth matrix, and finally the scalar value that is processed through a sigmoid function is used as the prediction result.

Specifically, the quantitative analysis method for a user decision-making behavior provided by this embodiment has the following beneficial effects that: through data-driven optimization design, the machine learning model is designed to be solving a nonconvex QCQP problem so as to build a machine learning model based on a deep learning framework, which can make further quantitative analysis for the decision factor, and thus obtain the final outputted scalar value related to each decision factor as the prediction result.

In an embodiment of the first aspect of the present application, the method further includes: receiving indication information, where the indication information is used to indicate a weight value of a regular term of the L2 norm; adjusting the weight value of the regular term of the L2 norm according to the indication information to increase the number of non-zero elements in the fourth matrix.

Specifically, the quantitative analysis method for a user decision-making behavior provided in this embodiment has the following beneficial effects that: an electronic device actively adjusts a value of at least one decision factor, that is, the electronic device can provide a more optimized decision factor based on a calculation result, which improves the degree of intelligence of the electronic device when making quantitative analysis on the user decision-making behavior, and enriches functions that can be provided.

In an embodiment of the first aspect of the present application, the method further includes: displaying the prediction result on a display interface.

Specifically, the quantitative analysis method for a user decision-making behavior provided in this embodiment has the following beneficial effects that: a result of user decision quantitative analysis can be presented to a merchant in a more intuitive way, so that the merchant can be connected to the analysis result through a visual interface, which reduces professional knowledge required by the merchant, reduces the difficulty of using, and improves use experience of the merchant.

A second aspect of the present application provides a quantitative analysis apparatus for a user decision-making behavior, including: an acquisition module, configured to acquire at least one decision factor related to making a target decision by a user; where each of the decision factor is represented by a numerical value obtained by quantifying information of the user or information of the target decision; a processing module, configured to input the at least one decision factor into a machine learning model, and determine, according to an output of the machine learning model, a prediction result of making the target decision by the user.

In an embodiment of the second aspect of the present application, the information of the user includes: a type of a decision that the user prefers to make, a time when the user makes the target decision, and a location where the user makes the target decision; the information of the target decision includes: a time distribution of the target decision being made cumulatively.

In an embodiment of the second aspect of the present application, the acquisition module is further configured to acquire multiple decisions made by the user and at least one decision factor related to each of the decisions; the processing module is further configured to input each decision of the multiple decisions and the at least one decision factor related to the each decision into the machine learning model in turn, and train the machine learning model.

In an embodiment of the second aspect of the present application, the machine learning model includes: an embedding module, a self projection attention module, a multilayer perceptron MLP module, and a decision structure learner module; where the embedding module is used to initialize each inputted decision factor as a multi-dimensional vector to obtain a first matrix; the self projection attention module is used to assign a value to each initialized vector in an embedding matrix according to a component projected by other vector on the each vector to obtain a second matrix; the MLP module is used to fuse the first matrix and the second matrix to obtain a third matrix, where the third matrix includes a likelihood value corresponding to each of the at least one decision factor, and the third matrix is subjected to regularization processing of an L2 norm to obtain a sparse fourth matrix; the decision structure learner module is used to determine a scalar value of making the target decision by the user according to the fourth matrix, and finally the scalar value that is processed through a sigmoid function is used as the prediction result.

In an embodiment of the second aspect of the present application, the acquisition module is further configured to receive indication information, where the indication information is used to indicate a weight value of a regular term of the L2 norm; the processing module is further configured to adjust the weight value of the regular term of the L2 norm according to the indication information to increase the number of non-zero elements in the fourth matrix.

In an embodiment of the second aspect of the present application, the apparatus further includes: a display module; where the display module is configured to display the prediction result on a display interface.

A third aspect of the present application provides an electronic device, including: at least one processor; and a memory communicatively connected with the at least one processor; where the memory stores instructions capable of being executed by the at least one processor, and the instructions are executed by the at least one processor to enable the at least one processor to execute the method provided in any one of the first aspect of the present application.

A fourth aspect of the present application provides a non-transitory computer-readable storage medium storing computer instructions, where the computer instruction are used to cause a computer to execute the method according to any one of the first aspect of the present application.

One of the above embodiments of the application has the following advantages or beneficial effects that: at least one quantified decision factor related to making the target decision by the user is inputted into the machine learning model, the machine learning model further analyzes the decision factor, and finally the prediction result of making the target decision by the user is determined according to an output of the machine learning model, so that the decision factor for making the target decision by the user can be analyzed to obtain the prediction result of making the target decision, which ensures the interpretability and effectiveness of the user decision-making behavior, and thus enriches the analysis needs for the user decision-making behavior. In addition, as the executive entity of the present application, the electronic device can output the prediction result of the target decision made by the user after acquiring at least one decision factor. The whole process is invisible to the user, and is equivalent to a black box, which is easy to use for the user, and also improves the efficiency of making quantitative analysis of the user decision-making behavior; with more convenient and intelligentized analysis by the electronic device, the merchant does not need to make analysis and judgment manually; a more universal machine learning model obtained based on big data can ensure the accuracy of an analysis result; and there is also a technical effect of improving the experience of users such as merchants.

Other effects of the above-mentioned optional implementations will be described below in conjunction with specific embodiments. It should be understood that the content described in this section is not intended to identify key or important features of embodiments of the present disclosure, nor is it intended to limit the scope of the present disclosure. Other features of the present disclosure will be easily understood through the following description.

### BRIEF DESCRIPTION OF THE DRAWINGS

The drawings are used to better understand the solutions, and do not constitute a limitation to the present application. Among them:

FIG. 1 is a schematic diagram of a technical scenario applied in the present application;

FIG. 2 is a schematic flowchart of an embodiment of a quantitative analysis method for a user decision-making behavior provided in the present application;

FIG. 3 is a schematic logical diagram of an embodiment of a quantitative analysis method for a user decision-making behavior provided in the present application;

FIG. 4 is a schematic logical diagram of another embodiment of a quantitative analysis method for a user decision-making behavior provided in the present application;

FIG. 5 is a schematic diagram of a vector corresponding to a decision factor provided in the present application;

FIG. 6 is a schematic structural diagram of an embodiment of a machine learning model provided in the present application;

FIG. 7 is a schematic logical diagram of another embodiment of a quantitative analysis method for a user decision-making behavior provided in the present application;

FIG. 8 is a schematic diagram of a display interface provided in the present application;

FIG. 9 is a schematic structural diagram of an embodiment of a quantitative analysis apparatus for a user decision-making behavior provided in the present application;

FIG. 10 is a schematic structural diagram of another embodiment of a quantitative analysis apparatus for a user decision-making behavior provided in the present application; and

FIG. 11 is a block diagram of an electronic device for a quantitative analysis method for a user decision-making behavior according to an embodiment of the application.

### DESCRIPTION OF EMBODIMENTS

FIG. 1 is a schematic diagram of a technical scenario applied in the present application. The present application is applied in the technical field of quantitative analysis of decisions made by users. Specifically, in an example shown in FIG. 1, an exemplary description is made by taking which merchant to go to as a decision made by a user. As shown in FIG. 1, assuming that merchants \textcircled{1}-\textcircled{3} are all restaurants, in one scenario, the user can choose to go to the merchant \textcircled{1} to have a meal according to better evaluation and more popularity of the merchant \textcircled{1}. In another scenario, the user can choose to go to the merchant \textcircled{2} to have a meal according to the closer distance of the merchant (D. In still another scenario, the user can also choose to go to the merchant \textcircled{3} to have a meal according to the provided good service and relatively complete service facilities of the merchant (D. It can be seen that when the user makes every decision, he/she will make a decision in combination with personal subjective habits on the basis of certain objective conditions. These subjective and objective conditions can affect a result of the user's decision, so they can be called decision factors.

With the development of big data technology, it is more convenient to acquire various decision factors corresponding to a large number of decisions made by users. After knowing the large number of decisions and the corresponding decision factors, how to quantify these large-scale data of decision factors, as well as further analysis and decision prediction after the quantification, are of more practical significance. For example, for a merchant, it is possible to predict whether a user chooses the merchant according to the user's decision factors, further understand a reason why the user makes a decision according to a prediction result, and better adjust some business strategies of the merchant and optimize resource allocation, thereby improving user experience, etc. For some service providers of an online recommendation system, they can more intelligently understand the subjective and objective reasons of the user's decision-making behavior according to the prediction result of the user's decision factors, so as to optimize the recommendation system and push a more accurate recommendation result to the user.

However, in the prior art, because the decisions made by the user are based on many decision factors, the analysis of the user decision-making behavior lacks a quantitative expression, and it is impossible to analyze the decision factors and make a decision prediction. As a result, even if there is a large amount of data on decisions and decision factors in the prior art, it is impossible to further analyze the user decision-making behavior. The method for user decision-making behavior analysis is relatively single and cannot meet diverse analysis needs for the user decision-making behavior.

Therefore, the present application proposes a quantitative analysis method for a user decision-making behavior and an apparatus. At least one quantified decision factor related to making a target decision by a user is inputted into a machine learning model; the machine learning model further analyzes the decision factor; and finally a prediction result of making the target decision by the user is determined according to an output of the machine learning model. Therefore, it is possible to analyze the decision factor for making the target decision by the user to obtain the prediction result of making the target decision, thus enriching analysis needs for the user decision-making behavior.

The technical solutions of the present application are described in detail below with specific embodiments. The following specific embodiments can be combined with each other, and the same or similar concepts or processes may be not repeated in some embodiments.

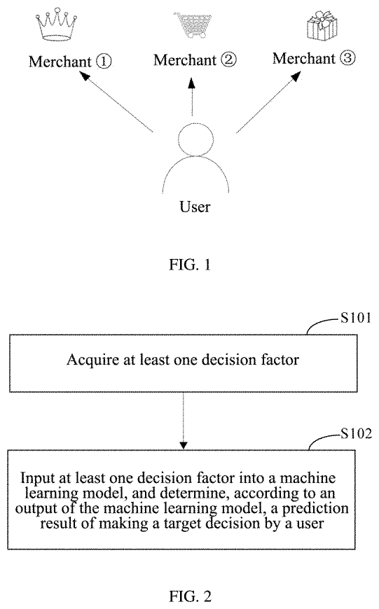

FIG. 2 is a schematic flowchart of an embodiment of a quantitative analysis method for a user decision-making behavior provided in the present application. As shown in FIG. 2, an executive entity of this embodiment may be an electronic device with relevant data processing capabilities such as a mobile phone, a tablet computer, a notebook computer, a desktop computer, or a server. Specifically, the quantitative analysis method for a user decision-making behavior provided by this embodiment includes:

S101: acquire at least one decision factor related to making a target decision by a user.

Specifically, in order to make quantitative analysis on a user decision-making behavior, the electronic device of this embodiment first acquires decision factors related to making the target decision by the user, and these decision factors acquired in this embodiment can all be quantified and expressed in a numerical form. The decision factors in this embodiment refer to subjective or objective conditions that can affect the user's judgment. These conditions can be divided into user-related information and information related to the target decision itself according to their sources. The information of the user includes a type of a target decision that the user prefers to make, a time when the user makes the target decision, and a location where the user makes the target decision; the information of the target decision includes: a time distribution of the target decision being made cumulatively.

Taking whether to choose a target merchant as an example of the target decision made by the user, the type of the target decision that the user prefers to make among the decision factors may be a type of going to a certain place that the user prefers to make. Such decision factor related to a user preference is related to a subjective wish of the user, and can be obtained statistically and recorded by a terminal device used by the user, such as a mobile phone, a tablet computer, according to the user's daily trajectories, search records, etc., or the terminal device can upload the statistically obtained type to the Internet for recording. For example, assuming that the user goes to coffee shops frequently and goes to parks relatively frequently, the terminal device performs statistics according to positioning information and other ways and finds out that the preferred places of the user can be coffee shops and parks, and quantifies these two kinds of places through numerical values 1—coffee shop and 2—park. Or to be more detailed, if the user often goes to a coffee shop X, a numerical value 11 is used to quantitatively describe the coffee shop X, and a numerical value 12 is used to quantitatively describe a coffee shop Y and so on. It is understandable that 1, 2, 11, and 12 here are only exemplary descriptions. In the actual representation process, the type of a certain place that the user prefers to go can be represented by more possible numerical values, and each numerical value represents a type of place; numerical values of types of the same place preferred by different users are the same.

The time when the user makes the target decision and the location where the user stays when making the target decision among the decision factors are related to an objective environment where the user is currently located, and can be obtained by the terminal device used by the user, such as a mobile phone, a tablet computer, and be uploaded to the Internet for recording. The time when the user makes a decision can be divided into different time periods for quantification representation. For example, each day is divided into four time periods including morning, noon, afternoon, and evening, which are represented by numerical values 1-4 in turn, and the time when the user makes the target decision is 10 am, which can be quantified by the numerical value “1”. The location where the user makes a decision can be represented by latitude and longitude data. Or map data can be divided into five areas including east, west, south, north, and middle, which are represented by numerical values 1-5 in turn, and the location where the user makes the target decision is the western part of the map, which can be quantified by the numerical value “2”.

The time distribution of the target decision being made cumulatively among the decision factors can specifically be a time distribution of user arrivals accumulated for a merchant. For example, the merchant can obtain a distribution of arrival time of users according to statistics. In the same way, each day can be divided into four time periods including morning, noon, afternoon, and evening, which are represented by numerical values 1-4 in turn. For the merchant corresponding to the target decision, if the number of users who arrive at the store in the eventing is the largest, data “4” can be used for quantification representation.

Optionally, the at least one decision factor acquired by the electronic device in S101 can be expressed quantitatively in the following manner {f1, f2, f3, f4}, where f1 is used to represent the type of the target decision that the user prefers to make, f2 is used to represent the time when the user makes the target decision, f3 is used to represent the location where the user makes the target decision, and f4 is used to represent the times when the target decision is made cumulatively. Therefore, based on the above example, at least one decision factor acquired by the electronic device may be {11, 1, 2, 4}, then “11” represents that the user often goes to the coffee shop X, “1” represents that the user makes the target decision in the morning, “2” represents that the location where the user makes the target decision is the western location of the map data, and “4” represents that the merchant corresponding to the target decision has the largest number of users in the store in the evening. It should be noted that this embodiment only shows several possible implementations of decision factors. In specific implementations, the decision factors may also include more conditions that influence the user to make the target decision, and so on, N decision factors acquired by the electronic device can be represented by {f1, f2, . . . , fN}. The decision factors provided in the embodiments of the present application can measure subjective and objective conditions of making the target decision by the user as comprehensively as possible from the user's perspective and from the perspective of the target decision itself, which can analyze the user decision-making behavior more accurately and descriptively.

Optionally, in one possible implementation, the electronic device can acquire, through an interactive device such as a mouse, a keyboard, at least one decision factor which is inputted by the merchant and related to making the target decision by the user; or, in another possible implementation, the user-related information can be actively reported by the user, or be automatically uploaded to an Internet server by the terminal device used by the user; a merchant-related decision factor can also be uploaded by the merchant to the Internet server, and the electronic device which is the executive entity of the present application acquires at least one decision factor through the Internet server. Or, optionally, after obtaining the decision factor, the electronic device can quantify the decision factor into a numerical expression according to a stored rule.

S102: Input at least one decision factor into a machine learning model, and determine, according to an output of the machine learning model, a prediction result of making the target decision by the user.

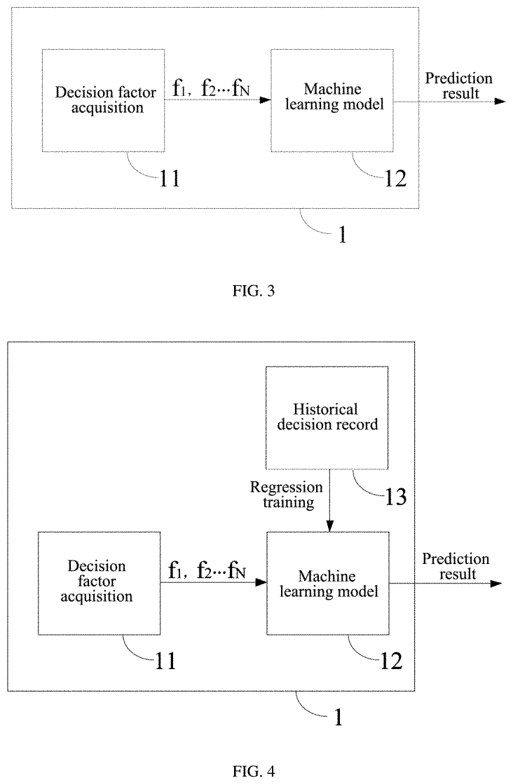

Subsequently, after obtaining the at least one decision factor in S101, the electronic device as the executive entity can input the decision factor into the machine learning model. In order to show this process more clearly and intuitively, FIG. 3 is a schematic diagram of an embodiment of a quantitative analysis method for a user decision-making behavior provided in the present application. After obtaining at least one decision factor (denoted as f1, f2, . . . , fN) in S101 through an acquisition module 11, the electronic device 1 as the executive entity of the present application can input the at least one acquired decision factor into the machine learning model 12 provided in the electronic device, and the machine learning model outputs a scalar value as the final prediction result which is outputted by the electronic device 1.

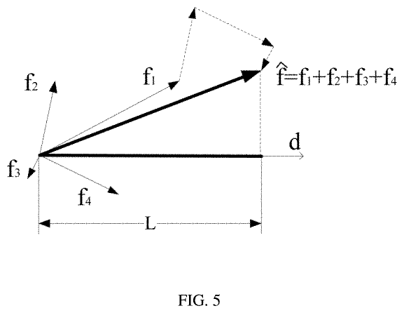

More specifically, the machine learning model provided in the embodiments of the present application is obtained by training through historical decision records of making the target decision by the user. The training process of the model is described in the following. FIG. 4 is a schematic diagram of another embodiment of a quantitative analysis method for a user decision-making behavior provided in the present application. The electronic device 1 acquires decision factors of the target decision that different users have made as historical decision records. For example, decision factors of a user A who has been to a merchant are {f1A, f2A, . . . , fNA}, decision factors of a user B are {f1B, f2B, . . . , fNB} . . . decision factors of a user N are {f1N, f2N, . . . , fNN}, then the electronic device 1 sequentially inputs the decision factors of the user A, the decision factors of the user B . . . the decision factors of the user N into the machine learning model 12, and the machine learning model performs regression training, to finally learn and obtain influence values of different decision factors of making the target decision by the user on the final result. The influence value can be a scalar value.

That is to say, the trained model can learn the influence of different decision factors on whether to make the target decision when the user makes the target decision, so that the machine learning model can be used in the method shown in FIG. 2 to make a judgment for at least one decision factor acquired this time, and can output a scalar value of whether the user makes the target decision based on the machine learning model. Therefore, the electronic device as the executive entity can analyze a reason for the user decision-making behavior in advance through historical decision data, so that an actual choice of the user can be restored more truly based on the machine learning model calculated from real data when subsequently analyzing each decision of the user, thereby analyzing the user decision-making behavior.

Optionally, the scalar value outputted by the machine learning model has a value range of 0-1 since it has been processed with a sigmoid function, then the electronic device can also perform processing before outputting it as a prediction result. For example, the scalar value outputted by the machine learning model can be divided into levels. A scalar value above 90% corresponds to a prediction result that “the user will definitely make the target decision”, a scalar value of 90%-40% corresponds to a prediction result that “the user may possibly make the target decision”, and a scalar value below 40% corresponds to a prediction result that “the user will not make the target decision”.

In summary, in the quantitative analysis method for a user decision-making behavior provided in this embodiment, at least one quantified decision factor related to making the target decision by the user is inputted into the machine learning model, the machine learning model further analyzes the decision factor, and finally the prediction result of making the target decision by the user is determined according to an output of the machine learning model, so that the decision factor for making the target decision by the user can be analyzed to obtain the prediction result of making the target decision, which ensures the interpretability and effectiveness of the user decision-making behavior, and thus enriches the analysis needs for the user decision-making behavior. In addition, as the executive entity of the present application, the electronic device can output the prediction result of the target decision made by the user after acquiring at least one decision factor. The whole process is invisible to the user, and is equivalent to a black box, which is easy to use for the user, and also improves the efficiency of making quantitative analysis of the user decision-making behavior; with more convenient and intelligentized analysis by the electronic device, the merchant does not need to make analysis and judgment manually; a more universal machine learning model obtained based on big data can ensure the accuracy of an analysis result; and there is also a technical effect of improving the experience of users such as merchants.

More specifically, the present application also provides a specific implementation of a machine learning model, which can be used to analyze a quantified decision factor and finally output a scalar value of whether a user will make a target decision.

In order to establish a machine learning model, the following problem need to be defined first: for a user behavior in making a target decision, in order to determine the possibility of the user making the target decision, at least one decision factor related to making the target decision by the user needs to be determined, as well as a weight corresponding to the decision factor; this process can also be called user decision profiling. In order to realize this process, the at least one acquired decision factor can be abstracted as a maximization scalar projection problem.

For example, FIG. 5 is a schematic diagram of a vector corresponding to a decision factor provided in the present application. For a target decision (D) made by the user, there can be at least one related decision factor (Factor) as a set {f1, f2, . . . , fN}, where each decision factor can be abstracted to be a vector of an n-dimensional space by embedding. Since each decision factor contributes to the target decision D differently, assuming there is a scalar vector (scalar projection), projection values obtained by different decision factors through this projection are different, that is, different decision factors contribute to the target decision making by the user in different degrees. Some decision factors increase the user's possibility of making the target decision, and some decision factors may reduce the user's possibility of making the target decision. For example, in an example shown in FIG. 5, directions and sizes of four scalar vectors f1, f2, f3, and f4 are all different. Adding the projected values of these four scalars can obtain the possibility of the user making the target decision, that is, the probability of D being successfully executed, which is expressed as a projection of \hat{f}=f1+f2+f3+f4 in FIG. 5, denoted as L, whose calculation formula is

$$L = \frac{{\hat{f}}^{T} d}{\vert d \vert} .$$

Finally, an objective of the above problem is translated into finding a projection and the embedding of the decision factors in each projection, so that the sum of a final projection value of the target decision is maximized.

In order to solve the problem of maximizing scalar projection, optimization design can be carried out in a data-driven manner. The above optimization design is to solve a nonconvex quadratically constrained quadratic programming (QCQP) problem. This nonconvex QCQP problem is again an NP-hard problem. Based on this, the machine learning model designed in the present application can be based on a deep learning framework and can be used for a problem of nonconvex QCQP approximate solution.

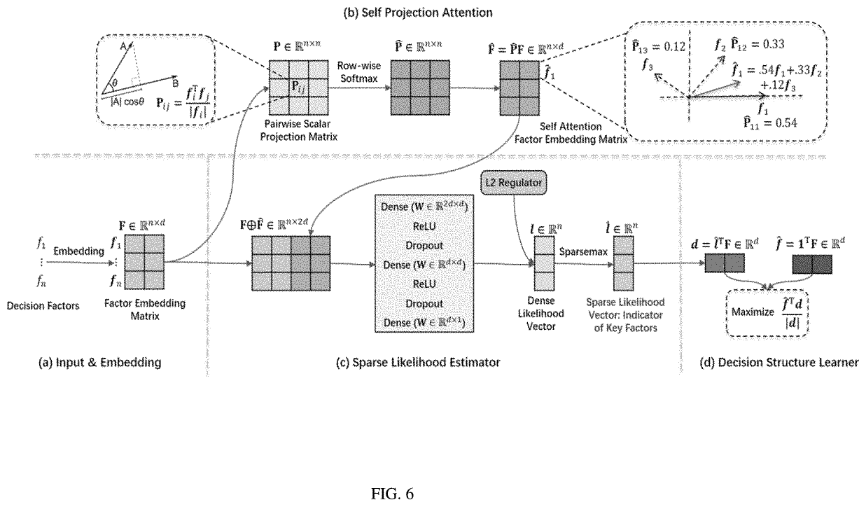

Specifically, FIG. 6 is a schematic structural diagram of an embodiment of a machine learning model provided in the present application. As shown in FIG. 6, the machine learning model provided in the present application includes: an embedding module, a self-projection attention module, a multilayer perceptron MLP module, and a decision structure learner module.

In conjunction with FIG. 6, a process of the machine learning model performing processing from at least one inputted decision factor to outputted probability of the target decision is described. For example, in part (a) shown in FIG. 6: in Input & Embedding, the machine learning model acquires at least one inputted decision factor, namely {f1, f2, . . . , fn} in the figure, embeds a numerical value of each decision factor as a d-dimensional vector by way of embedding, and forms n d-dimensional vectors into a matrix with a dimension of n*d, that is, a factor embedding matrix F in the figure, denoted as a first matrix, for subsequent calculation.

Subsequently, in the Self Projection Attention module of part (b) shown in FIG. 6, according to the established first matrix, a projection of each vector is calculated by the formula

$${P}_{i j} = \frac{{\hat{f}}_{i}^{T} {f}_{j}}{\vert {f}_{i} \vert} ,$$

to establish an n*n-dimensional matrix P for intermediate calculation. In combination with the above formula, it can be seen that each element in a second matrix is used to represent, for a vector of any target decision factor, a projection of a vector of other decision factor on the vector of the target decision factor. It is understandable that the larger the projection value of the vector of other decision factor on the vector of the target decision factor is, the greater the influence of that decision factor on the target decision factor is; the smaller the projection value of the vector of other decision factor on the vector of the target decision factor is, the smaller the influence of that decision factor on the target decision factor is. Then the matrix P is subjected to softmax processing, and a value corresponding to the vector of each decision factor in the matrix P is assigned according to the degree of importance. The resulting matrix is denoted as \hat{P}, and can be used to represent a sum of the projection values of other decision factors for any decision factor. Then a matrix \hat{F} with a dimension of n*d, denoted as the second matrix, is obtained by multiplying the matrix P carrying weight values with the original first matrix F.

Subsequently, in the Sparse Likelihood Estimator of part (c) as shown in FIG. 6, the first matrix and the second matrix are fused through a multilayer perceptron (MLP), to obtain a matrix l with a vector dimension of n*1 denoted as a third matrix, which includes a likelihood value corresponding to each of n decision factors. The matrix l is processed through a regularization function of an L2 norm (L2 regulator) to obtain a sparse matrix \hat{l}, denoted as a fourth matrix.

Finally, in the Decision Structure Learner of part (d) as shown in FIG. 6, through the matrixes that have been calculated before, a scalar value L of the target decision is calculated according to the formulas d=\hat{l}′F (obtaining d by a calculation using the fourth matrix and the first matrix), \hat{f}=l′F (obtaining \hat{f} by a calculation using a matrix with each element value being 1 and the first matrix), and

$$L = maximize \frac{{\hat{f}}^{T} d}{\vert d \vert} ;$$

then L is processed through the sigmoid function to map L to [0,1], which is finally outputted as the prediction result.

It should be noted that in the machine learning model shown in FIG. 6, during the training process of the machine learning model, training contents include a changing parameter of embedding, specific value-assignment methods of softmax and sparsemax, etc., so that in the subsequent process of use, at least one decision factor of the current calculation can be calculated through the trained parameters. For specific implementations of calculations of embedding, softmax, Sparsemax, L2 norm, etc., please refer to the prior art, which will not be repeated.

Optionally, in the embodiments of the present application, when performing calculation through the machine learning model as shown in FIG. 5, the electronic device as the executive entity can also adjust a weight value of a regular term of the used L2 norm according to calculation needs from users or merchants. For example, when the third matrix contains more zero elements but fewer non-zero elements, if it is desirable to consider more decision factors, the weight value of the regular term of the L2 norm can be adjusted, so that the number of zero elements is less and the number of non-zero elements is more in the fourth matrix obtained after the regularization processing of the L2 norm. Then the electronic device can receive indication information sent by the user through an interactive device such as a mouse, a keyboard, and the indication information is used to indicate the set weight value of the regular term of the L2 norm.

Optionally, the electronic device can also adjust the value of at least one decision factor, so that a scalar value, which is outputted after the at least one adjusted decision factor is inputted into the machine learning mode, is greater than a scalar value which is outputted after the at least one current decision factor (before being adjusted) is inputted into the machine learning model. That is, the electronic device can provide a more optimized decision factor according to a calculation result, so that the final scalar value is larger or maximum.

For example, the specific value of at least one decision factor {f1, f2, f3, f4}, which is inputted into the machine learning model by the electronic device, is {11, 1, 2, 4}, and the value L calculated by the machine learning model shown in FIG. 6 is 0.5. The electronic device can adjust f2 to 2, and input the new array {11, 2, 2, 4} into the machine learning model for calculation. At this time, the calculated L is 0.6, which is greater than the value calculated from the previous data, thereby providing a better combination of decision factors. Optionally, if the computing power of the electronic device allows, the electronic device can list all possible combinations of decision factors, and finally find a combination of decision factors that can output the largest value of L as the most optimal combination of decision factors, which is presented to merchants through a display interface and other ways.

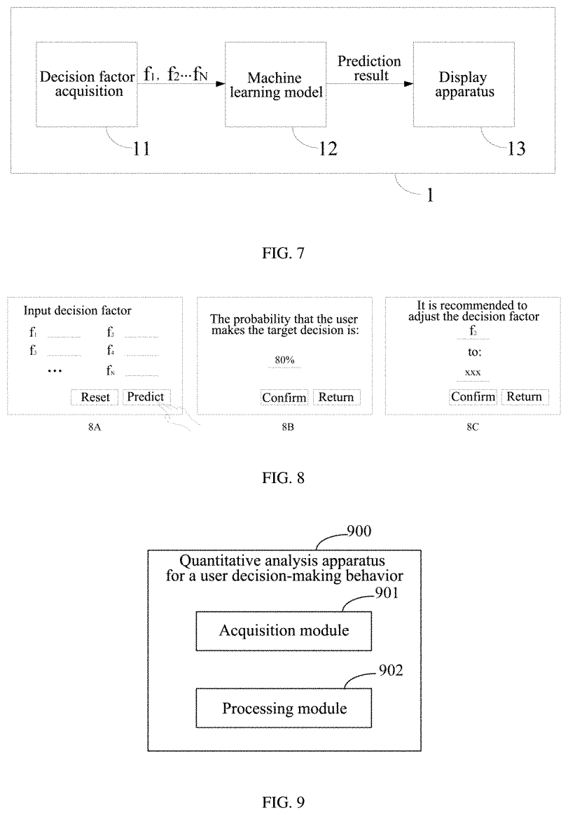

Further, the electronic device provided in the present application can also include an interactive device such as a display apparatus, for interacting with a merchant who uses the electronic device. For example, FIG. 7 is a schematic logical diagram of another embodiment of a quantitative analysis method for a user decision-making behavior provided in the present application. In an example shown in FIG. 7, the electronic device 1 further includes a display apparatus 13.

Illustratively, FIG. 8 is a schematic diagram of a display interface provided in the present application. As shown in FIG. 8, as the executive entity of the quantitative analysis method for a user decision-making behavior provided in the present application, the electronic device can display an input box through the display interface 8A on the display apparatus before executing the method, allowing the merchant to input at least one decision factor, and after the user clicks a “Predict” control, perform the calculation in the embodiment shown in FIG. 2. Finally, after the prediction result of making the target decision by the user is obtained by calculation, the final prediction result is displayed on the display interface 8B on the display apparatus as “80%”. Therefore, in this embodiment, the electronic device can present a quantitative analysis result of a user's decision to the merchant in a more intuitive way, so that the merchant can be connected to the analysis result through a visual interface, which reduces professional knowledge required by the merchant, reduces the difficulty of using, and improves use experience of the merchant.

The methods provided in the embodiments of the present application are introduced in the above embodiments provided in the present application. In order to realize the functions in the methods provided in the above embodiments of the present application, the electronic device as the executive entity may include a hardware structure and/or software module. The above functions are realized in the form of hardware structure, software module, or hardware structure plus software module. Whether a certain function of the above-mentioned functions is executed in a hardware structure, a software module, or a hardware structure plus a software module depends on specific application and design constraint conditions of the technical solution.

For example, FIG. 9 is a schematic structural diagram of an embodiment of a quantitative analysis apparatus for a user decision-making behavior provided in the present application. As shown in FIG. 9, the quantitative analysis apparatus 900 for a user decision-making behavior provided in this embodiment includes an acquisition module 901 and a processing module 902, where the acquisition module 901 is configured to acquire at least one decision factor related to making a target decision by a user; where each of the decision factor is represented by a numerical value obtained by quantifying information of the user or information of the target decision information; the processing module 902 is configured to input the at least one decision factor into a machine learning model, and determine, according to an output of the machine learning model, a prediction result of making the target decision by the user.

The quantitative analysis apparatus for a user decision-making behavior provided in this embodiment can be used to implement the method shown in FIG. 2, and their implementation and principle are the same, and will not be repeated.

Optionally, the information of the user includes: a type of a decision that the user prefers to make, a time when the user makes the target decision, and a location where the user makes the target decision; the information of the target decision includes: a time distribution of the target decision being made cumulatively.

Optionally, the acquisition module 901 is further configured to acquire multiple decisions made by the user and at least one decision factor related to each of the decisions; the processing module 902 is further configured to input each decision of the multiple decisions and the at least one decision factor related the each decision into the machine learning model in turn, and train the machine learning model.

Optionally, the machine learning model includes: an embedding module, a self-projection attention module, a multilayer perceptron MLP module, and a decision structure learner module; where the embedding module is used to initialize each inputted decision factor as a multi-dimensional vector to obtain a first matrix; the self-projection attention module is used to assign a value to each initialized vector in an embedding matrix according to a component projected by other vector on the each vector to obtain a second matrix; the MLP module is used to fuse the first matrix and the second matrix to obtain a third matrix, where the third matrix includes a likelihood value corresponding to each of the at least one decision factor, and the third matrix is subjected to regularization processing of an L2 norm to obtain a sparse fourth matrix; the decision structure learner module is used to determine a scalar value of making the target decision by the user according to the fourth matrix, and finally the scalar value that is processed through a sigmoid function is used as the prediction result.

Optionally, the acquisition module 901 is further configured to receive indication information, the indication information being used to indicate a weight value of a regular term of the L2 norm; the processing module 902 is further configured to adjust the weight value of the regular term of the L2 norm according to the indication information to increase the number of non-zero elements in the fourth matrix.

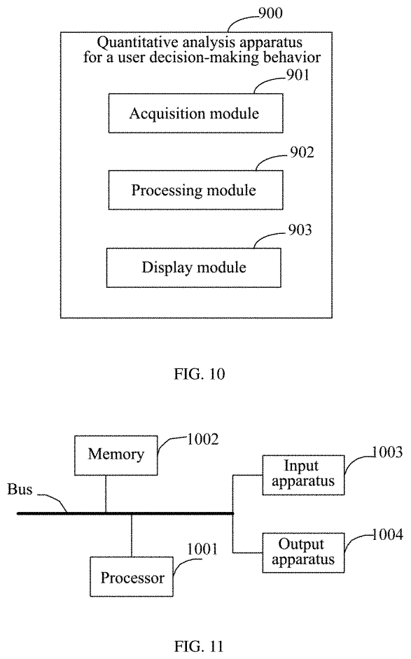

FIG. 10 is a schematic structural diagram of another embodiment of a quantitative analysis apparatus for a user decision-making behavior provided in the present application. The apparatus shown in FIG. 10 further includes a display module 903 based on the embodiment shown in FIG. 9; where the display module 903 is configured to display the prediction result on a display interface; and/or the display module 903 is configured to display the at least one decision factor, which is adjusted, on the display interface.

According to the embodiments of the present application, the present application also provides an electronic device and a readable storage medium.

FIG. 11 is a block diagram of an electronic device for a quantitative analysis method for a user decision-making behavior according to an embodiment of the present application. The electronic device is intended to represent various forms of digital computers, such as a laptop computer, a desktop computer, a workstation, a personal digital assistant, a server, a blade server, a mainframe computer, and other suitable computers. The electronic device can also represent various forms of mobile apparatuses, such as a personal digital assistant, a cellular phone, a smart phone, a wearable device, and other similar computing apparatuses. The components shown herein as well as their connections and relationships and their functions are merely examples, and are not intended to limit the implementation of the present application described and/or required herein.

As shown in FIG. 11, the electronic device includes: one or more processors 1001, a memory 1002, and interfaces for connecting various components, including high-speed interfaces and low-speed interfaces. The various components are connected to each other using different buses, and can be installed on a common motherboard or installed in other ways as required. The processor can process instructions executed in the electronic device, including instructions stored in or on the memory to display GUI graphical information on an external input/output apparatus (such as a display device coupled to an interface). In other implementations, if necessary, multiple processors and/or multiple buses can be used with multiple memories. Similarly, multiple electronic devices can be connected, and each device provides some necessary operations (for example, as a server array, a group of blade servers, or a multi-processor system). In FIG. 11, one processor 1001 is taken as an example.

The memory 1002 is the non-transitory computer-readable storage medium provided by the present application. The memory stores instructions that can be executed by at least one processor, so that the at least one processor executes the quantitative analysis method for a user decision-making behavior provided in the present application. The non-transitory computer-readable storage medium of the present application stores computer instructions, and the computer instructions are used to cause a computer to execute the quantitative analysis method for a user decision-making behavior provided in the present application.

As a non-transitory computer-readable storage medium, the memory 1002 can be used to store a non-transitory software program, a non-transitory computer-executable program and modules, such as the program instructions/modules (for example, the acquisition module 901 and the processing module 902 shown in FIG. 9 and FIG. 10) corresponding to the quantitative analysis method for a user decision-making behavior in the embodiments of the present application. The processor 1001 executes various functional applications and data processing of a server by running the non-transitory software program, instructions, and modules stored in the memory 1002, that is, realizing the quantitative analysis method for a user decision-making behavior in the foregoing method embodiments.

The memory 1002 may include a program storage area and a data storage area. The program storage area may store an operating system and an application program required by at least one function; the data storage area may store data created according to the use of the electronic device for quantitative analysis of the user decision-making behavior. In addition, the memory 1002 may include a high-speed random access memory, and may also include a non-transitory memory, such as at least one magnetic disk storage device, a flash memory device, or other non-transitory solid-state storage devices. In some embodiments, the memory 1002 may optionally include memories remotely set with respect to the processor 1001, and these remote memories may be connected to the electronic device for quantitative analysis of the user decision-making behavior through a network. Examples of the above-mentioned network include, but are not limited to, the Internet, an intranet, a local area network, a mobile communication network, and combinations thereof.

The electronic device for the quantitative analysis method for a user decision-making behavior may further include: an input apparatus 1003 and an output apparatus 1004. The processor 1001, the memory 1002, the input apparatus 1003, and the output apparatus 1004 may be connected through a bus or in other ways. In FIG. 10, a connection through a bus is taken as an example.

The input apparatus 1003 can receive inputted digital or character information, and generate a key signal input related to user settings and function control of the electronic device for the quantitative analysis method for a user decision-making behavior, such as a touch screen, a keypad, a mouse, a track pad, a touch pad, a pointing stick, one or more mouse buttons, a trackball, a joystick and other input apparatuses. The output apparatus 1004 may include a display device, an auxiliary lighting apparatus (for example, an LED), a tactile feedback apparatus (for example, a vibration motor), and the like. The display device may include, but is not limited to, a liquid crystal display (LCD), a light emitting diode (LED) display, and a plasma display. In some embodiments, the display device may be a touch screen.

Various implementations of the systems and technologies described herein can be implemented in a digital electronic circuit system, an integrated circuit system, a dedicated ASIC (application specific integrated circuit), computer hardware, firmware, software, and/or combinations thereof. These various implementations may include: being implemented in one or more computer programs, where the one or more computer programs may be executed and/or interpreted on a programmable system including at least one programmable processor, and the programmable processor may be a dedicated or general programmable processor, which can receive data and instructions from the storage system, at least one input apparatus and at least one output apparatus, and transmit data and instructions to the storage system, the at least one input apparatus and the at least one output apparatus.

These computing programs (also called programs, software, software applications, or codes) include machine instructions of a programmable processor, and these computing programs can be implemented by utilizing a high-level process and/or an object-oriented programming language, and/or an assembly/machine language. As used herein, the terms “machine-readable medium” and “computer-readable medium” refer to any computer program product, device, and/or apparatus (for example, a magnetic disk, an optical disk, a memory, a programmable logic device (PLD)) used to provide machine instructions and/or data to the programmable processor, including machine-readable media that receive machine instructions as machine-readable signals. The term “machine-readable signal” refers to any signal used to provide machine instructions and/or data to the programmable processor.

In order to provide interaction with the user, the systems and technologies described here can be implemented on a computer having: a display apparatus for displaying information to the user (for example, a CRT (cathode ray tube) or an LCD (liquid crystal display) monitor); a keyboard and a pointing device (for example, a mouse or trackball) through which the user can provide inputs to the computer. Other types of apparatuses may also be used to provide interaction with the user; for example, a feedback provided to the user may be any form of sensing feedback (for example, visual feedback, auditory feedback, or tactile feedback); and the inputs from the user may be received in any form (including acoustic input, voice input, or tactile input).

The systems and technologies described here can be implemented in a computing system that includes back-end components (for example, as a data server), or a computing system that includes middleware components (for example, an application server), or a computing system that includes front-end components (for example, a user computer with a graphical user interface or a web browser through which the user can interact with the implementation of the systems and technologies described herein), or a computing system that includes any combination of such back-end components, middleware components or front-end components. The components of the system can be connected to each other through any form or medium of digital data communication (for example, a communication network). Examples of the communication network include: a local area network (LAN), a wide area network (WAN), and the Internet.

A computer system can include a client and a server. The client and server are generally far away from each other and usually interact with each other through a communication network. The relationship between the client and the server is generated by computer programs running on corresponding computers and having a client-server relationship with each other. The server may be a cloud server, also known as a cloud computing server or a cloud host, which is a host product in a cloud computing service system and has solved defects of difficult management and weak business scalability in traditional physical host and VPS services.

It should be understood that reordering, adding or deleting of steps may be performed for the various forms of processes shown above. For example, the steps described in the present application can be performed in parallel, sequentially, or in a different order, as long as the desired result of the technical solution disclosed in the present application can be achieved, which is not limited herein.

The above specific implementations do not constitute a limitation on the protection scope of the present application. Those skilled in the art should understand that various modifications, combinations, sub-combinations and substitutions can be made according to design requirements and other factors. Any amendments, equivalent substitutions, improvements and others that are made within the spirit and principle of the present application shall be included in the protection scope of the present application.

What is claimed is:

1. A quantitative analysis method for a user decision-making behavior, comprising:
acquiring at least one decision factor related to making a target decision by a user; wherein each of the decision factor is represented by a numerical value obtained by quantifying information of the user or information of the target decision;
inputting the at least one decision factor into a machine learning model, and determining, according to an output of the machine learning model, a prediction result of making the target decision by the user.

2. The method according to claim 1, wherein:
the information of the user comprises: a type of a decision that the user prefers to make, a time when the user makes the target decision, and a location where the user makes the target decision;
the information of the target decision comprises: a time distribution of the target decision being made cumulatively.

3. The method according to claim 2, further comprising:
acquiring multiple decisions made by the user and at least one decision factor related to each of the decisions;
inputting each decision of the multiple decisions and the at least one decision factor related to the each decision into the machine learning model in turn, and training the machine learning model.

4. The method according to claim 1, wherein:
the machine learning model comprises: an embedding module, a self-projection attention module, a multilayer perceptron MLP module, and a decision structure learner module;
wherein the embedding module is used to initialize each inputted decision factor into a multi-dimensional vector to obtain a first matrix; the self-projection attention module is used to assign a value to each initialized vector in the first matrix according to a component projected by other vector on the each vector to obtain a second matrix; the MLP module is used to fuse the first matrix and the second matrix to obtain a third matrix, wherein the third matrix comprises a likelihood value corresponding to each of the at least one decision factor, and the third matrix is subjected to regularization processing of an L2 norm to obtain a sparse fourth matrix; the decision structure learner module is used to determine a scalar value of making the target decision by the user according to the fourth matrix, and finally the scalar value that is processed through a sigmoid function is used as the prediction result.

5. The method according to claim 4, further comprising:
receiving indication information, wherein the indication information is used to indicate a weight value of a regular term of the L2 norm;
adjusting the weight value of the regular term of the L2 norm according to the indication information to increase the number of non-zero elements in the fourth matrix.

6. The method according to claim 5, further comprising:
displaying the prediction result on a display interface.

7. A quantitative analysis apparatus for a user decision-making behavior, comprising:
at least one processor; and
a memory communicatively connected with the at least one processor; wherein,
the memory stores instructions capable of being executed by the at least one processor, and the instructions are executed by the at least one processor, so that the at least one processor is configured to:
acquire at least one decision factor related to making a target decision by a user; wherein each of the decision factor is represented by a numerical value obtained by information of the user or information of the target decision;
input the at least one decision factor into a machine learning model, and determine, according to an output of the machine learning model, a prediction result of making the target decision by the user.

8. The apparatus according to claim 7, wherein:
the information of the user comprises: a type of a decision that the user prefers to make, a time when the user makes the target decision, and a location where the user makes the target decision;
the information of the target decision comprises: a time distribution of the target decision being made cumulatively.

9. The apparatus according to claim 8, wherein the at least one processor is configured to:
acquire multiple decisions made by the user and at least one decision factor related to each of the decisions;
input each decision of the multiple decisions and the at least one decision factor related to the each decision into the machine learning model in turn, and train the machine learning model.

10. The apparatus according to claim 7, wherein:
the machine learning model comprises: an embedding module, a self-projection attention module, a multilayer perceptron MLP module, and a decision structure learner module;
wherein the embedding module is used to initialize each inputted decision factor into a multi-dimensional vector to obtain a first matrix; the self-projection attention module is used to assign a value to each initialized vector in the first matrix according to a component projected by other vector on the each vector to obtain a second matrix; the MLP module is used to fuse the first matrix and the second matrix to obtain a third matrix, wherein the third matrix comprises a likelihood value corresponding to each of the at least one decision factor, and the third matrix is subjected to regularization processing of an L2 norm to obtain a sparse fourth matrix; the decision structure learner module is used to determine a scalar value of making the target decision by the user according to the fourth matrix, and finally the scalar value that is processed through a sigmoid function is used as the prediction result.

11. The apparatus according to claim 10, wherein the at least one processor is configured to:
receive indication information, wherein the indication information is used to indicate a weight value of a regular term of an L2 norm;
adjust the weight value of the regular term of the L2 norm according to the indication information to increase the number of non-zero elements in the fourth matrix.

12. The apparatus according to claim 11, wherein the at least one processor is configured to:
display the prediction result on a display interface.

13. A non-transitory computer-readable storage medium storing computer instructions, wherein the computer instructions are used to cause a computer to execute the following steps:
acquiring at least one decision factor related to making a target decision by a user; wherein each of the decision factor is represented by a numerical value obtained by information of the user or information of the target decision;
inputting the at least one decision factor into a machine learning model, and determine, according to an output of the machine learning model, a prediction result of making the target decision by the user.

14. The non-transitory computer-readable storage according to claim 13, wherein:
the information of the user comprises: a type of a decision that the user prefers to make, a time when the user makes the target decision, and a location where the user makes the target decision;
the information of the target decision comprises: a time distribution of the target decision being made cumulatively.

15. The non-transitory computer-readable storage according to claim 14, wherein the computer is further caused to execute the following steps:
acquiring multiple decisions made by the user and at least one decision factor related to each of the decisions;
inputting each decision of the multiple decisions and the at least one decision factor related to the each decision into the machine learning model in turn, and training the machine learning model.

16. The non-transitory computer-readable storage according to claim 13, wherein the machine learning model comprises: an embedding module, a self-projection attention module, a multilayer perceptron MLP module, and a decision structure learner module;
wherein the embedding module is used to initialize each inputted decision factor into a multi-dimensional vector to obtain a first matrix; the self-projection attention module is used to assign a value to each initialized vector in the first matrix according to a component projected by other vector on the each vector to obtain a second matrix; the MLP module is used to fuse the first matrix and the second matrix to obtain a third matrix, wherein the third matrix comprises a likelihood value corresponding to each of the at least one decision factor, and the third matrix is subjected to regularization processing of an L2 norm to obtain a sparse fourth matrix; the decision structure learner module is used to determine a scalar value of making the target decision by the user according to the fourth matrix, and finally the scalar value that is processed through a sigmoid function is used as the prediction result.

17. The non-transitory computer-readable storage according to claim 16, the computer is further caused to execute the following steps:
receiving indication information, wherein the indication information is used to indicate a weight value of a regular term of the L2 norm;
adjusting the weight value of the regular term of the L2 norm according to the indication information to increase the number of non-zero elements in the fourth matrix.

18. The non-transitory computer-readable storage according to claim 17, wherein the computer is further caused to execute the following step:
displaying the prediction result on a display interface.
